(19) United States
(12) Patent Application Publication
(10) Pub. No.: US 2015/0370974 A1
(43) Pub. Date: Dec. 24, 2015

(54) Doctor Device for Coordinated In Person Delivery of Medical Services

(71) Applicant: Medicast, Inc., Alpharetta, GA (US)

(72) Inventors: Nafis Zebarjadi, Palo Alto, CA (US); Sameen Zebarjadi, Johns Creek, GA (US); Sahba Ferdowsi, Coral Gables, FL (US)

(73) Assignee: Medicast, Inc., Alpharetta, GA (US)

(21) Appl. No.: 14/465,775

(22) Filed: Aug. 21, 2014

Related U.S. Application Data
(60) Provisional application No. 62/014,798, filed on Jun. 20, 2014.

(51) Int. Cl. G06F 19/00

(52) U.S. Cl. CPC G06F 19/327; G06F 19/322; G06F 19/328

(57) ABSTRACT

Doctors may be matched with patients desiring or needing medical care. A doctor computing device may be used to manage workload, to set an on call status, to receive patient requests for medical services and associated information, to communicate with a potential patient, to navigate to a patient location, to create or process medical records, to process billing, and other purposes. A doctor may be matched to a patient request for medical services by a coordination component. Doctor/patient matches may be made based upon location information, the medical needs of the patient, the medical practice of the doctor, gender, language skills, or any other criteria. A doctor may accept or decline a request for medical services from a patient. A bi-directional and at least partially anonymized communication may be initiated by a doctor to permit the doctor to evaluate the medical needs of a patient.

### CROSS-REFERENCE TO RELATED APPLICATIONS

This application claims the benefit of provisional patent application Ser. No. 62/014,790, entitled “Coordinated In Person Delivery of Medical Services,” filed on Jun. 20, 2014, which is incorporated herein by reference. This application is also related to patent application Ser. No. ______ filed on Aug. ______, 2014 entitled “Coordinated In Person Delivery of Medical Services,” and to patent application Ser. No. ______ filed on Aug. ______, 2014 entitled “Patient Device for Coordinated In Person Delivery of Medical Services,” and to patent application Ser. No. ______ filed on Aug. ______, 2014 entitled “Management for Coordinated In Person Delivery of Medical Services,” each of which is incorporated herein by reference.

### FIELD OF INVENTION

The present invention relates to the provision of medical services to patients. More particularly, the present invention relates to the coordination of the matching of doctors to patients for the delivery of medical services and the subsequent in person delivery of the medical services by a doctor.

### BACKGROUND AND DESCRIPTION OF THE RELATED ART

The provision of medical services has evolved to be highly complicated and often expensive. The complexity and cost of the modern medical system may pose challenges to both medical patients and medical doctors. While some medical conditions require intrinsically complicated treatments and/or diagnosis techniques, many routine medical issues require only rudimentary equipment and a talented doctor in order to identify and resolve a patient's medical issue. While the basic medical care many general practice and/or urgent care physicians provide to patients may not require a high level of complexity, such doctors typically are part of larger organizations that manage medical practices and, importantly, manage issues such as insurance billing, medical records, and other aspects related more to the business side of medical services than the actual practice of medicine. This additional complexity, typically even for the often straightforward medical issues presented for a general practitioner and/or urgent care physician, often frustrates both patients and doctors.

### SUMMARY OF THE INVENTION

The present invention coordinates the delivery of medical services to patients by doctors. Systems and methods in accordance with the present invention provide efficient and mutually convenient medical services to patients that do not require a complex medical infrastructure to address their medical needs.

A variety of information relevant to the delivery of medical services to a patient may be collected via a patient computing device. Any type of computer may be used as a patient computing device, such as a personal computer, smart phone, tablet computer, or any other type of device. The patient computing device may be connected to a network permitting the patient computing device to interact with and to communicate with other computing devices. Enrollment data may be collected using a patient computing device, and may comprise information such as information regarding billing, plan selection, and/or other information. The information collected and provided by a patient using a patient computing device may also comprise physiological information describing the patient herself or himself. For example, physiological information may involve age, gender, health history, and other relevant demographic or medical information that may be valuable to a doctor providing medical services to the patient. Information such as language preferences and/or abilities, preferred characteristics for a doctor, or other information that may be useful in matching a doctor with the patient may be requested. In some examples of the present invention, a patient may be permitted to select a preferred doctor from a list of available doctors. A patient may also provide symptomatic information. Symptomatic information may be descriptions of the symptoms giving rise to a request for medical services or otherwise related to the requested medical services. Of course, patient payment information may be collected as well. In some examples, patients may enroll with a service that provides medical services, such that payment information, as well as possibly physiological information, need not be entered repeatedly. Further, location information describing the geographical position of the patient may be collected, such as by entering a street address on the part of the patient or through use of location services, such as a GPS, operating on a computing device associated with the patient.

Doctors participating in systems providing medical services in accordance with the present invention may provide information regarding themselves and/or their practices. For example, a doctor's gender, medical specialty, and/or language skills may be relevant to the provision of medical services to a patient. Further, a doctor's location may be provided either by the doctor herself or himself or through the use of location services, such as a GPS device, operating on a computing device associated with the doctor. In some examples, a patient may select a preferred doctor from the doctors available to attend to the patient. Doctors may also provide information regarding their status for availability to provide medical services. For example, a doctor's status may be “on call” or “not on call,” with only doctors designating themselves as “on call” available for matching with patient requests. By way of further example, a doctor's status may be more than a binary on call/not on call option, such as being occupied by a patient, being available only for certain types of requests or certain types of patients, etc. A status may optionally be specified by a doctor directly, for example using an interface on a doctor medical device, but may also be inferred, for example based upon whether the doctor has accepted but not completed a patient request.

A system and/or method in accordance with the present invention may match requests for medical services from patients with a doctor based upon a variety of criteria. For example, a doctor may be matched with a patient request based upon physical proximity to the patient. In the example of matching based upon physical proximity, a doctor may be matched with a patient if the doctor may reach the patient's location the most quickly of available doctors. Travel time for a doctor may be calculated using location data of both the patient and the doctor, and may take into account known traffic or transit conditions, weather conditions, prior trips by that doctor, etc. Other criteria beyond proximity may be used to match one doctor from a sub-set of available doctors who may reach the patient within a specified amount of time, such as one hour, two hours, a business day, etc. Patient location data and doctor location data may also be used in matching a doctor with a patient's request for medical services in conjunction with a base location associated with a doctor, for example to prevent a doctor from being matched to patient requests beyond a certain distance and/or travel time from that doctor's base of operations. Criteria beyond location that may be used in matching a patient request for medical services to a doctor may comprise one or more criteria. For example, a patient may indicate a preference for a doctor of a particular gender, having particular language skills, or practicing a particular medical specialty. Location data may be used in performing a match between a doctor and a patient in ways other than and/or in addition to a calculation of travel time likely to be required for the doctor to reach a patient, but may identify a doctor within the same region, sub-region, municipality or neighborhood, etc., and accordingly match a doctor to a patient requesting medical services such that the travel will be efficient but also such that both individuals may have similar local knowledge and experience, which may be useful for providing medical advice and suggesting treatment. Moreover, systems and methods in accordance with the present invention may identify physiological or symptomatic information from a patient indicative of a need for a particular medical specialty in a doctor and accordingly match a doctor with specialized medical expertise to the request for medical services of a given patient. Further, different doctors may possess different supplies, whether by choice or because of prior use in previous medical treatments, and a doctor may be matched to a patient request based upon the medical supplies, medicines, and/or diagnostic tools available to the doctor. Workloads of doctors may also be managed, so that all available doctors receive sufficient rest to be capable of providing high quality medical services, and accordingly the prior workload of doctors may be taken into account in matching a doctor with a patient medical request. Algorithms balancing these and other matching criteria to achieve an optimal match between a patient request for medical services and a doctor may be used in accordance with the present invention. In some examples, when more than one doctor is identified as a match to a patient request, the patient may be asked to select one doctor or rank the doctors by preference in order to make the final match between a patient and a doctor.

In order for a doctor to better evaluate his or her ability to meet the medical needs of a patient, systems and methods in accordance with the present invention may permit a doctor to initiate a bidirectional communication, such as a voice call, with the patient. The bidirectional communication may be partially or entirely anonymized in order to protect the privacy and confidentiality of both the doctor and the patient prior to the creation of a doctor-patient relationship. Bidirectional communications that may optionally be entirely or partially anonymized and used for communications between a doctor and a patient in accordance with the present invention may be, for example, two legged calls established via the publicly switched telephone network (“PSTN”), voice over Internet protocol (“VoIP”) calls, text or other types of messaging, electronic mail, video conferencing, or any other communications media permitting the bidirectional exchange of information between a doctor and a patient. The bi-directional communications may be anonymized in any fashion. For example, communications may be at least partially anonymized through the use of an intermediary device, such as a coordination component or other device, that removes metadata or other potentially identifying information associated with communication data exchanged between a doctor and a potential patient.

Systems and methods in accordance with the present invention may permit a doctor to accept or decline a patient's request for the delivery of medical services. The declination of a request for the provision of medical services may lead to an attempt at matching another doctor to the patient's medical request or the notification of the patient that his or her medical request will not or cannot be matched. Different types of reasons for declining a request for the delivery of medical services may result in different actions. For example, if a doctor declines a request for medical services based upon the reasonable belief due to the information received from the potential patient, records of prior treatment/requests for treatment, and/or and a bidirectional communication that the potential patient is seeking prescription drugs for an illegal or illicit use, the doctor may indicate such in declining to accept the request for medical services and, accordingly, the patient may be informed that the requested medical services will not be provided. On the other hand, a doctor may decline a request for medical services with a different or no reason provided, such as being still occupied with a different medical call or feeling sick herself, in which case systems and methods in accordance with the present invention may proceed to match a different doctor to the medical request of the patient. In this fashion, systems and methods in accordance with the present invention may provide patients convenient and rapid access to quality medical services while providing doctors control over their own schedules and medical practice.

Systems and methods in accordance with the present invention may provide a medium for a doctor to keep her or his medical notes, records, charts, or other materials. Such medical records may be maintained and/or made initially on a computing device associated with the doctor, and those records may subsequently be communicated to a coordination component and/or other computing device over at least one network for retention, backup, future billing, analysis, or other purposes. Further, medical resources, such as diagnostic guides, pharmaceutical guides, and other useful information, may be provided to a doctor via a computing device associated with the doctor in accordance with the present invention. Similarly, medical instructions, treatment advice, and similar information that may help a patient after the provision of medical services and/or during the recovery process may be provided in accordance with the present invention using a patient associated computing device.

Systems and methods in accordance with the present invention may manage the payment process between a patient or other payor and a doctor. In this fashion, a doctor may provide medical services to patients without becoming enmeshed in the accounting and billing aspects of the delivery of medical services. Systems and methods in accordance with the present invention may match a patient's medical requests with doctors only after verifying the enrollment status of the potential patient, payment status of the patient, and/or the payment capability of the patient, thereby permitting a doctor to focus solely on the delivery of medical services. While the doctor benefits from the assurance of receiving payment for the delivery of medical services, a patient using systems and methods in accordance with the present invention benefits from the timely and convenient delivery of medical services and efficient provision of services, resulting in a lower cost to the patient then may be obtained through more conventional medical service delivery means.

### BRIEF DESCRIPTION OF THE SEVERAL VIEWS OF THE DRAWINGS

Examples of systems and methods in accordance with the present invention are described in conjunction with the attached drawings, wherein:

FIG. 1 schematically illustrates a system in accordance with the present invention;

FIG. 2 schematically illustrates examples of components that may be present in a computing device associated with a patient in accordance with the present invention;

FIG. 3 schematically illustrates examples of components that may be present in a computing device associated with a doctor in accordance with the present invention;

FIG. 4 illustrates an example of a method in accordance with the present invention;

FIG. 5 schematically illustrates an exemplary flow of information within an example system in accordance with the present invention;

FIG. 6 illustrates an example interface for entering a patient's medical history in accordance with the present invention;

FIG. 7 illustrates an example interface for entering a patient's symptom information in accordance with the present invention;

FIG. 8 illustrates an example interface for entering diagnosis information in accordance with the present invention;

FIG. 9 illustrates an example interface for recording medicine(s) administered in accordance with the present invention;

FIG. 10 illustrates an example interface for summarizing medical services provided and presenting billing information;

FIG. 11 illustrates an example interface for setting an on call status by a doctor;

FIG. 12 illustrates an example interface notifying a doctor of a request for medical services and associated information;

FIG. 13 illustrates an example interface permitting a doctor to request a bi-directional and potentially at least partially anonymized communication with a potential patient;

FIG. 14 illustrates an example interface for a doctor to decline a request for medical services from a patient;

FIG. 15 illustrates an example navigational component providing directions permitting a doctor to travel to a patient location; and

FIG. 16 illustrates an example method of providing medical services.

### DETAILED DESCRIPTION

Systems and methods in accordance with the present invention may match patient requests for medical services with doctors able and desirous of fulfilling those patient requests. Both the patient and the doctor may have one or more computing devices associated with him/her to facilitate both the matching of the patient and the doctor and the ultimate provision of the desired medical services. A computing device, whether associated with a patient or a doctor, may comprise any type of computing device, such as a personal computer running any type of operating system, a mobile telephone or smart phone, a tablet computer, a set top box associated with a television and/or video streaming service, a gaming system, or any other type of computing device. A computing device may connect, either directly or indirectly, to a communication network. Examples of communication networks include, but are not limited to, the Internet, intranets, local area networks, wide area networks, or any other type of communication network. Communication networks in accordance with the present invention may utilize one or more communication protocols, and the protocol or protocols used are not limited in accordance with the present invention. For example, networks accessed either directly or indirectly by computing devices in accordance with the present invention maybe packet-based networks, circuit-based networks, or any other type of communication network. In some examples, a computing device may comprise a smart phone or tablet computer, such as an iPhone® or iPad®, that communicates with other computing devices via protocols such as TCP/IP over the Internet. Protocols such as, but not limited to, HTTPs using TLS/SSL encryption may be used for some or all data exchanged between computing devices operating within systems and/or methods in accordance with the present invention. In some examples, systems and methods in accordance with the present invention may operate, at least in part, using a software application or “app” installed on a computing device and providing an appropriate interface for the patient, doctor, or other individual to use. However, systems and methods in accordance with the present invention are not limited to such an example, and may, for example, comprise the use of a web browser or other software or device to present an appropriate interface and to exchange information between computing devices in accordance with the present invention.

Systems and methods in accordance with the present invention may be implemented using computer or machine readable code embodied on non-transitory media. The computer or machine readable code may cause one or more machine or computing device to execute a method or parts of a method in accordance with the present invention, and/or to operate as part of a system in accordance with the present invention. The non-volatile computer or machine readable media containing such instructions may be located at a single location or computing device or may be distributed over multiple locations and/or multiple computing devices.

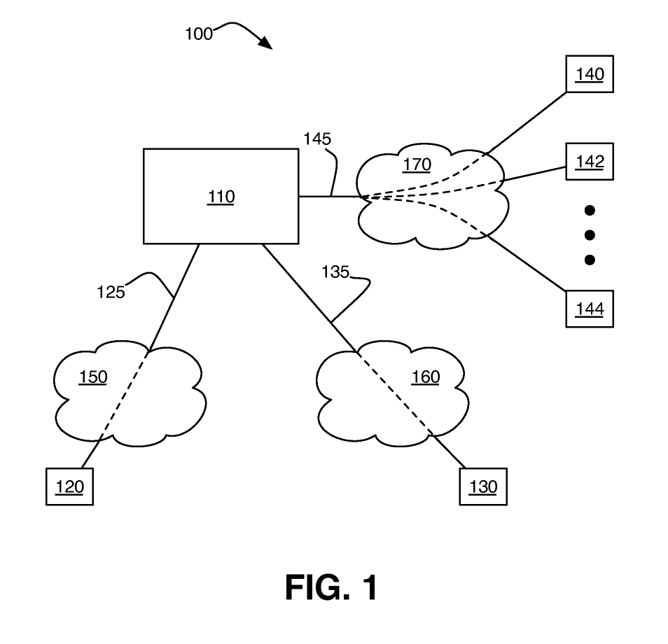

Referring now to FIG. 1, one example of a system 100 in accordance with the present invention is illustrated. A coordination component 110 may match patient requests for medical services with doctors. Coordination component 110 may comprise one or more computing device or multiple computing devices. Coordination component 110 may comprise one or more server, a peer-to-peer network, a distributed network, or any other type of system or network executing machine readable code to perform methods as described herein and/or to operate as part of a system as described herein.

Still referring to FIG. 1, a patient computing device 120 may be used to provide information regarding a patient and/or to request medical services. Patient medical device 120 may establish a connection 125 with coordination component 110 through a network 150. In actual practice, network 150 may comprise a plurality of disparate networks, potentially operating over different media and using different communication protocols, and connection 125 may comprise multiple connections that may be physical or virtual. For example, a connection such as connection 125 may be destination and source addresses used for packet routing and transmission.

Referring still to FIG. 1, a doctor computing device 130 may connect 135 via a network 160 with coordination component 110, similar to the fashion described with regard to patient computing device 120 connecting 125 via network 150. Coordination component 110 may use data obtained from patient computing device 120 and doctor computing device 130 to match a request for medical services from a patient with a doctor able and desiring to meet that medical request. In practice, patient medical requests may be made using a patient computing device 120 different from a patient computing device 120 that provided other information associated with the patient, such as payment information, physiological information, or other details. Similarly, doctor computing device 130 may actually comprise more than one computing device, with different information relevant to the doctor being provided and/or received using different computing devices 130.

In addition to information received from a patient computing device 120 and a doctor computing device 130, coordination component 110 may use information obtained from external sources, such as a first information source 140, a second information source 142, and an nth information source 144. For example, a first information source 140 or other external source may provide routing information, traffic information, or other information potentially useful in determining whether a given doctor can reach a given patient within a desired amount of time; may provide information for use in parsing a patient request to identify an area of specialization needed in providing medical services to a patient; may identify a potential patient as a habitual seeker of prescription drugs for illicit or illegal purposes; may provide information relevant to regulatory or licensing considerations in a given jurisdiction; or any other information. In some examples, information may be provided within coordinating component 110 rather than in an external information source. As shown in the example of FIG. 1, coordination component 110 may access a first communication connection 145 over a network 172 to obtain information from a first information source 140, a second information source 142, up to an nth information source 144. However, as described above with regard to connection 125 and network 150 permitting a patient computing device 120 to exchange information with a coordination component 110, the coordinating component 110 may connect 145 via a network 170 with information sources 140, 142, 144 via a variety of protocols, media, etc.

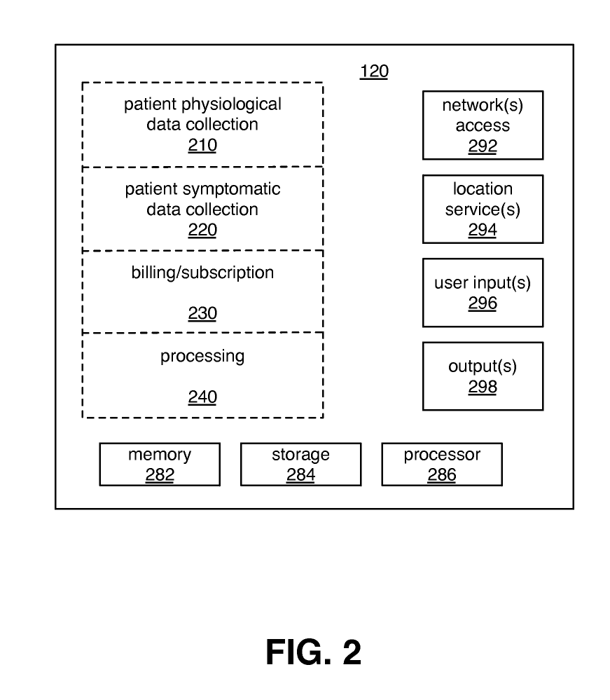

Referring now to FIG. 2, one example of components of a potential patient computing device 120 in accordance with the present invention is illustrated. Some of the components illustrated in the example of FIG. 2 as part of a patient computing device 120 may be an intrinsic part of a computing device used by a patient, while other components may be added, for example via the installation of software and/or hardware in accordance to the present invention.

Some components of a patient computing device 120 may be part of a patient interface in accordance with the present invention. For example, a patient may provide physiological data using a patient physiological data collection component 210. Patient physiological data may be provided during or after an enrollment or subscription process. An enrollment or subscription process for a patient may proceed using a billing or subscription interface 230. When a patient affirmatively requests medical services, a patient may enter symptomatic information using a patient symptomatic data collection component 220. A processing component 240 may preliminarily process information entered by a patient, for example during enrollment using a billing/subscription component 230, a symptomatic data collection component 220, and/or a physiological data collection component 210 to identify omissions in data, to provide potential suggestions to a patient, and/or to provide notifications of possible concerns to a patient. For example, processing component 240 may parse or otherwise analyze the patient's symptomatic data in order to advise the patient to seek medical emergency care for his chest pains rather than to seek medical services using systems or methods in accordance with the present invention. In some examples, systems and methods in accordance with the present invention may contact emergency services directly if an emergency medical situation is detected.

Still referring to the example of FIG. 2, a patient computing device 120 may provide access to one or more network via a network access component 292. Network access component 292 may interface with, for example, one or more communication network. A communication network may operate using a mobile telephone protocol (such as data or voice networks associated with GSM and/or CDMA networks), LTE protocols, WiMAX protocols, various 802.11 protocols such as various Wi-Fi standards, Bluetooth and other communication standards, ethernet communications, or any other type of network access protocol. Patient computing device 120 may further provide one or more type of location service component 294. One example of location services that may be used in accordance with the present invention is GPS, which may provide a highly precise geographical location for the patient computing device 120. Other types of location service components 294 may alternatively or additionally use information obtained from beacons, known wireless hotspots or tower locations, triangulation of known sources or beacons, and/or the entry of location data by a patient or other individual using patient computing device 120. Patient computing device 120 may provide one or more user input component 296 and one or more output component 298. Some user input mechanisms may also comprise output mechanisms, either simultaneously or alternatively. For example, a touchscreen may be used both to provide outputs to a user, such as a patient, and to receive inputs from a user, such as a patient, via physical touching or contacting of the touchscreen. Other types of input components 296 may comprise a keyboard (whether physical or virtual) a pointing device such as a mouse, a stylus used in conjunction with a screen responsive to contact by the stylus, voice recognition or other types of voice commands, one or more button, a joystick, a lever, a pedal, a remote control, or other device capable of registering an input from a user. Similarly, an output component 298 may comprise any type of display, projection system, speaker, tactile device, or other component that provides an output perceivable by a user, such as a patient.

Still referring to the example of FIG. 2, a patient computing device may provide one or more computer processor 286 that executes computer or machine readable code to execute methods or to perform as part of a system in accordance with the present invention. The computer or machine readable instructions executed by a processor such as processor 286 may be retained in computer memory 282 and or in a computer readable storage 284. Storage 284 may further be utilized to maintain a record of activities performed by patient computing device 120 relevant to systems and methods in accordance with the present invention, such as to maintain a record of patient physiological data, symptomatic data, and communications exchanged between a patient using patient computing device 120 and a doctor. In accordance with the present invention, records relevant to the operation of systems and methods in accordance with the present invention that may be retained in storage 284 may be encrypted or otherwise secured for privacy concerns.

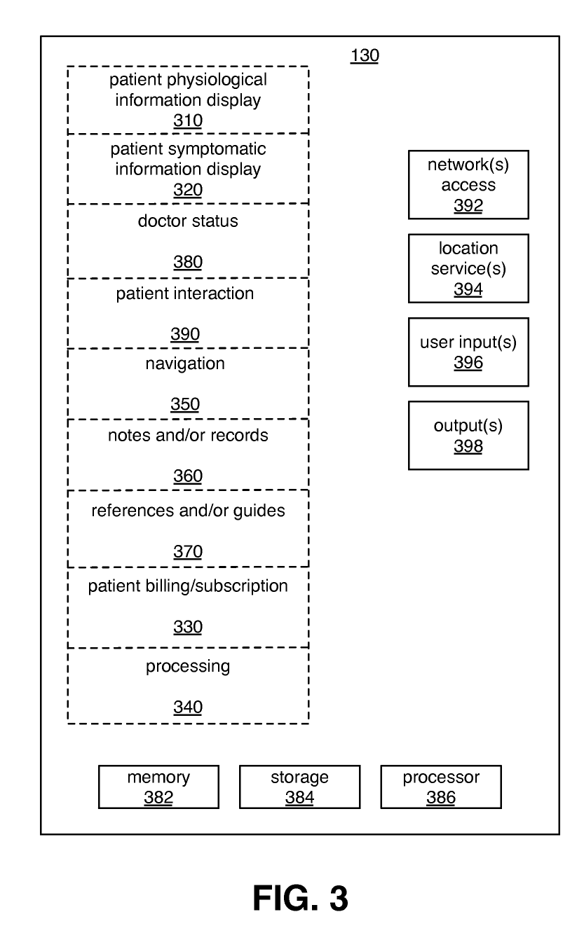

Referring now to FIG. 3, an example of a doctor computing device 130 in accordance with the present invention is illustrated. Many of the components of the exemplary doctor computing device 130 may resemble some or all components described with regard to patient computing device 120 in conjunction with FIG. 2. In the example of FIG. 3, doctor computing device may similarly provide one or more of a network access component 392, a location services component 394, a user input component 396, and output component 398, one or more processor component 386, memory 382, and storage 384.

Still referring to the example of FIG. 3, a doctor computing device 130 may provide various components as part of a doctor interface. Some components of a doctor interface component operating on doctor computing device 130 may exchange information, either directly or indirectly, with components operating on a patient computing device 120, either within or without a patient interface, and/or with components operating on a coordination component 110. As shown in the example of FIG. 3, a patient physiological data display component 310 may provide a physician using doctor computing device 130 information describing the physiological details of a patient making a request for medical services. Similarly, a patient symptomatic display component 320 may provide information describing the symptoms reported by a patient requesting medical services. The physiological information displayed in component 310 and the symptomatic information displayed in component 320 may be particularly relevant for a physician using doctor computing device 130 to determine whether to provide the requested medical services, as a doctor using computing device 130 may prefer not to provide requested medical services unless the doctor is confident as to her or his ability to deliver the highest quality medical services.

A doctor interface component 310 of a doctor computing device 130 may also provide a status designation 380, that may be adjustable by the doctor. The status designation 380 may permit a doctor to toggle between “on call” and “not on call” or similar states to indicate whether the doctor is available for matching with patient requests in accordance with the present invention. The status designation 380 need not be binary, however, and may permit a doctor to make himself or herself available for only certain types of medical requests, requests within a given geographical area, requests from a particular type of patient (such as a patient previously treated by that doctor), etc.

Still referring to the example of FIG. 3, a doctor interface component operating on a doctor computing device 130 may provide patient billing or subscription information 330, so as to enable a doctor to ascertain a patient's membership or payment status within a system or method in accordance with the present invention, although in many examples systems and methods in accordance with the present invention will only provide information regarding verified member patients to a participating doctor. A doctor computing device 130 may further comprise a processing component that may assist a doctor using computing device 130 in matching patient physiological and/or symptomatic data with potential diagnoses or to alert a doctor to potential risks based upon information a doctor has or is entering as part of the treatment plan or from other medical notes or records for a patient and the treatment of the patient. Patient medical records may be recorded in notes, medical charts, or other appropriate form in records component 360. Doctor using doctor computing device 138 may also access medical reference or guide component 370 to facilitate the diagnosis and/or treatment of a patient requesting medical services. A doctor interface operating on a doctor computing device 130 may further provide a doctor the opportunity to initiate a bidirectional communication with a patient requesting medical services using a patient interaction component 390. Such a bidirectional communication may permit the doctor to better ascertain the medical needs and desires of a patient, as well as to evaluate the doctor's abilities to perform the desired medical services. A bidirectional communication between a doctor and a patient initiated using a patient interaction component 390 may utilize the computing device(s) associated with the patient, for example patient computing device 120, and the computing device(s) associated with the doctor, for example doctor computing device 130, but need not. Further, the bidirectional communication initiated by a doctor using patient interaction component 390 of doctor computing device 130 may be entirely or partially anonymized. In this fashion, the privacy of both the doctor and the potential patient may be maintained and respected. Coordination component may establish an at least partially anonymized bidirectional communication, either in whole or in part and either directly or indirectly. One example of a bidirectional communication that may be initiated using doctor computing device 130 is a telephone call using the publicly switched telephone network. The selection of an initiation request for a bidirectional communication by a doctor using a computing device 130 may cause a system, such as a coordination component described above, to initiate a call between the patient and the doctor at a telephone number provided by each and then to join those to call legs together into a single telephone call with neither doctor nor patient obtaining the other's telephone number via caller identification or a similar service. Such a telephone call may be directed through a coordination component 110, but may also be directed through any component of a telephone network, optionally at the initiation of a coordination component 110. Other types of bidirectional communications may be used without departing from the scope of the present invention, however. For example, if the present invention is embodied in all or in part on an application operating on the patient computing device 120 and/or the doctor computing device 130, a VoIP call may be established, with a desired level of anonymity, between doctor computing device 130 and patient computing device 120, either within or without the application or other software embodying the aspects of present invention described elsewhere herein. Other types of bidirectional communication that may be partially or entirely anonymized in accordance with the present invention are messaging services, video conferencing, electronic mail type services, or any other type of messaging that exchanges bidirectional communications over intervening networks using text, audio, video, or other form to communicate between a doctor and a patient.

While the examples of FIG. 2 and FIG. 3 illustrate a single patient computing device 120 and a single doctor computing device 130, the present invention does not limit a patient or a doctor to a single computing device. For example, a patient may enroll into a system in accordance with the present invention using a personal computer, and may later enter physiological information pertinent to the patient using a tablet computer. Subsequently, the patient may request medical services using a smartphone. Similarly, a doctor may initially enroll using a first computing device and may subsequently access or be alerted to requests for medical services from patients using a different computing device.

In some examples of systems and methods in accordance with the present invention, a doctor computing device 130 may provide a navigation component 350 within a doctor interface on doctor computing device 130. Navigation component 350 may provide navigational instructions sufficient to permit a doctor to physically travel to the location provided for patient using the location services component 294 of the patient computing device 120. Navigation component 350 may utilize location services component 394 of doctor computing device 130 to facilitate the travel (by automobile, foot, public transit, or any other mode of travel) of a doctor carrying doctor computing device 130 to travel to the location of patient and patient computing device 120. In order to protect and respect the privacy of a patient making a request for medical services using a patient computing device 120, the navigation component 350 of a doctor interface on a doctor computing device 130 may optionally not provide a precise location sufficient to navigate to a patient location until a doctor has affirmatively indicated a willingness to accept a patient using the doctor interface on the doctor computing device 130, but may rather provide an anonymized indication of the general area of the patient.

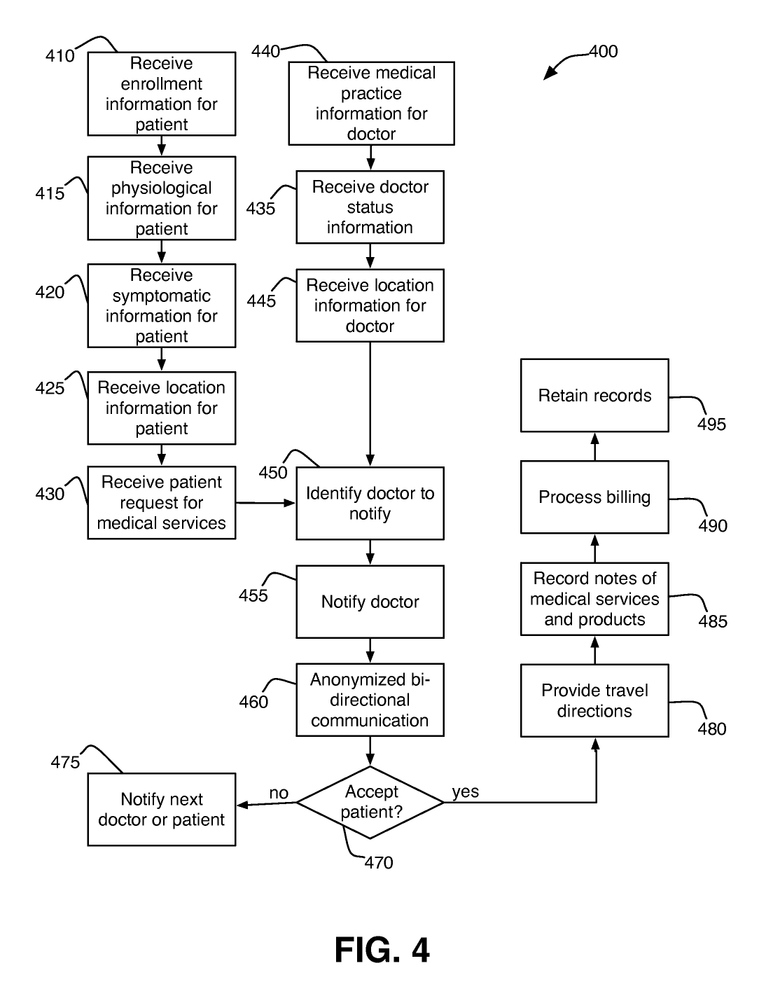

Referring now to FIG. 4, a method 400 in accordance with the present invention is illustrated. While method 400 represents only a single example of potential methods in accordance with the present invention, method 400 is described for exemplary purposes herein. Various steps described with regard to method 400 may be performed in orders different than presented herein, and further may sometimes be omitted entirely. Further, method 400 may have steps in addition to those described herein, and steps described herein may comprise multiple substeps or other components that may always or sometimes be performed in a method in accordance with the present invention.

As shown in the example of FIG. 4, method 400 may involve an enrollment step 410 in which a patient provides and a system in accordance with the present invention receives enrollment information for a patient. Step 410 may involve a patient signing (electronically or otherwise) a contract for the provision of medical services, providing payment information to permit the receipt of payment for delivery medical services, the creation of an ongoing enrollment in a program for the delivery of medical services, etc. Step 410 may be associated with establishing and/or verifying an insurance plan, but need not involve any type of insurance program. In step 415 physiological information for a patient may be received. Step 415 may occur simultaneous with step 410 or at a different time. Physiological information received in step 415 may comprise basic information potentially pertinent to the delivery of medical care, such as the age, gender, medical history, and other information describing a potential patient. In step 420 symptomatic information for a patient may be received. The information received in step 420 may, for example, be in conjunction with a specific request for the provision of medical services. The symptomatic information received in step 420 may describe a particular illness, a particular injury, or other circumstance related to the request for medical services using method 400 by a patient. Step 420 may occur substantially simultaneously with step 410 (enrollment) and/or step 415 (physiological information collection). In step 425 location information may be received for a patient. Step 425 may involve the transmission of GPS coordinates from a patient computing device, the provision of other location information from a patient computing device, or the patient inputting information (such as a street address) describing the patient's location. The culmination of such steps may involve the receipt of a patient request for medical services in step 430. The request received in step 430 may be defined in varying degrees by a patient or by systems and methods in accordance with the present invention.

Method 400 may also receive information describing doctors available to provide medical services. Medical practice information may be received for a doctor in step 440. Medical practice information may describe the training and/or medical background of a doctor, but may also describe information potentially pertinent to the delivery of medical services, such as the doctor's age, gender, language skills, a doctor's medical practice preferences, groups or types of patients well suited to a doctor's experience or expertise, or other information. Doctor status information may be received in step 435 in order to permit systems in accordance with the present invention to determine whether a doctor is available to be matched with a request for medical services by a potential patient. Method 400 may further receive location information for a doctor in step 445. Location information for a doctor received in step 445 may involve, for example, the receipt of GPS or other location information from a location services component of a doctor computing device, but may also involve a doctor entering location information using an input device.

Systems and methods in accordance with the present invention may identify a doctor to notify with regard to a request for medical services in a matching step 450. The doctor identified in step 450 may be based upon physical proximity to a patient based upon location information, medical practice information, or any other criteria. In some examples more than one doctor may be identified as a potential match and a patient may be presented with an option to choose a preferred doctor, with such a selection of a doctor by a potential patient happening either before ore after a doctor has accepted the request for medical services. Once a match has been made to identify a particular doctor 450 to potentially service a medical request for a patient received in step 430, the doctor may be notified in step 455. Step 455 may comprise, for example, issuing an alert or other notification on a doctor's computing device, paging a doctor, telephoning a doctor, emailing a doctor, or any other way of communicating with the doctor. The notification step 455 may further provide additional information regarding the request for medical services, such as symptomatic information received in step 420, physiological information received in step 415, location information received in step 425 (which may be anonymized to protect patient privacy, as described above) or any other pertinent information. Matching step 450 may optionally identify multiple doctors as candidates for providing the requested medical services, in which case notification step 455 may notify multiple doctors of the match and permit one of the multiple doctors to accept the request to provide medical services.

A doctor may initiate a bidirectional communication with a patient in step 460. The bidirectional communication initiated in step 460 may be partially or entirely anonymized to protect the privacy of both the doctor and patient. In some instances, bidirectional communication step 460 may be omitted. Based on information obtained in the bidirectional communication of step 460 and/or the notification of step 455, a doctor may decide whether or not to accept a patient in step 470. If the decision of a doctor in step 470 is not to accept a patient, method 400 may proceed to step 475 of notifying a further doctor of a request for medical services or of notifying the patient that medical services will not be provided. As described above, in some circumstances a doctor may decline to provide medical services for reasons that, in accordance with systems and methods of the present invention, may indicate that a patient is either a poor fit for the provision of medical services in accordance with the present invention (for example, if an ambulance should be called) or that the provision of the requested or desired medical services may result in undesired ethical or legal risks to a doctor (for example, if a patient is believed to be seeking prescription medication for abuse or other illicit purposes) the patient may be simply advised that medical services may not be provided. On the other hand, in some instances a doctor may wish to decline to provide requested medical services for reasons involving doctor's medical judgment or personal preferences, in which case step 475 may match a patient request for medical services with a different doctor in accordance with method 400 as described above.

If the outcome of step 470 is that a doctor chooses to accept a request for the provision of medical services, a doctor may be provided travel directions in step 480 to permit the doctor to reach the patient. Step 480 may comprise providing non-anonymized and navigable patient location information to a doctor computing device, such that the doctor computing device may generate travel direction, either independently or in conjunction with other computing device(s). In step 485, notes or other records of medical services and products provided may be recorded. Step 485 may occur during a bidirectional communication, during the issuance of a request for medical services, and/or after the arrival at a patient location by a doctor. Method 400 may process billing for a patient in step 490. Step 490 may optionally occur without direct involvement by a doctor. Further, pertinent records, such as those recorded in step 485, may be retained in step 495. Step 495 may retain the medical records made by a doctor, the information provided by a patient as physiological information in step 415, as symptomatic information in 420, as location information in step 425 or as part of an anonymized or partially anonymize bidirectional communication in step 460.

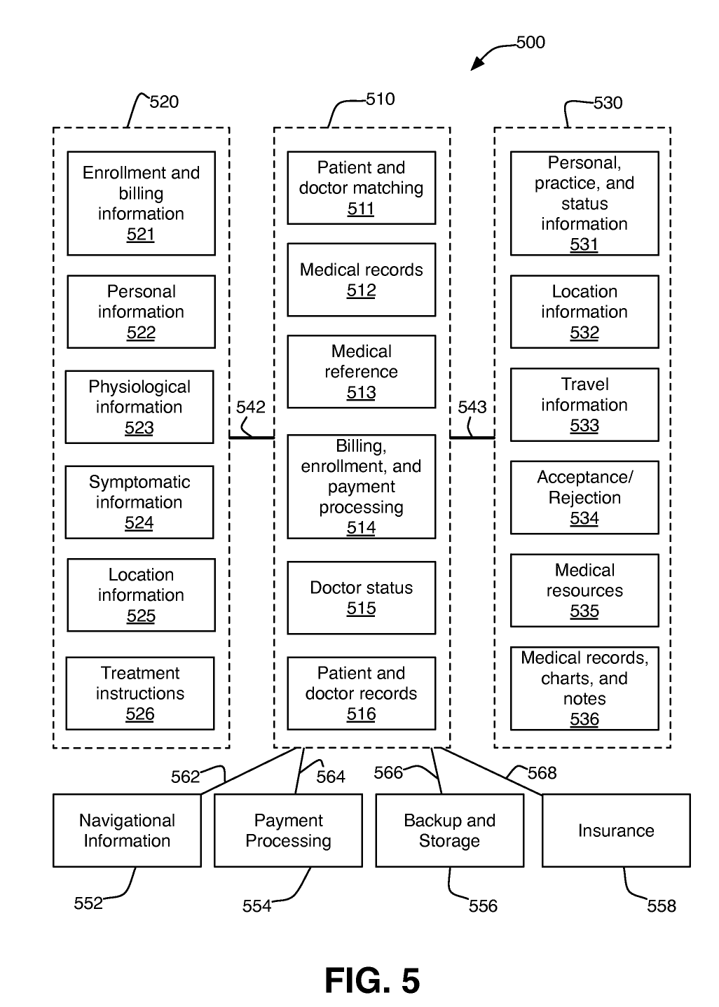

Referring now to FIG. 5, the interaction of example components and the transmission in exchange of information in exemplary systems and methods in accordance with the present invention is illustrated. In the example of FIG. 5, a coordination component 510 may provide various services and functions. For example, patient and doctor matching component 511 may use various criteria to match a patient request for medical services with a doctor available to provide those services. Coordination component 510 may further provide medical record functionality to, for example, retain or provide in the first instance medical records pertinent to a patient and/or a patient's request for medical services. Further, a coordination component 510 may provide a medical reference functionality to provide information both to a doctor and to a patient. Coordination component 510 may utilize medical reference component 513 to provide different types or categories of information that may be pertinent to different entities. For example, medical reference component 513 may provide diagnostic or dosing information to a doctor, but may provide treatment guidelines for instructions for following a treatment plan to a patient. Medical reference component may comprise multiple specialized components devoted to one of either a doctor or the patient or to particular medical areas or specialties. Further, coordination component 510 may provide a billing, enrollment, and/or payment processing component 514. Billing, enrollment, and or payment processing component 514 may manage all or part of the initial enrollment of patients within a system or method in accordance with the present invention, the payment of bills related to the provision of particular medical services and/or products, and the general management of patients and billing issues. Component 514 may base billing upon medical record information, such as the types of medical products or services provided to a patient by a doctor. Coordination component 510 may further provide a doctor status component 515 that may maintain information regarding the doctors available for potential matches with patient needs. Coordination component 510 may also maintain records of prior interactions or requests of participating doctors and/or patients in a record component 516. Information maintained in record component 516 may be used to match doctors with patients who have previously received care from that doctor (and optionally when the patient has provided a positive evaluation or other response to the doctor) or to avoid matching a doctor to a patient if that matching has been unfavorable before.

Coordination component 510 may exchange information with a patient component 520, a doctor component 530, and optionally with other components. A patient component 520 may provide enrollment and billing information, personal information (such as the language preferences of a patient), physiological information 523, symptomatic information 524, location information 525, and treatment instructions for a patient 526.

Meanwhile, a doctor component 530 may provide personal, practice, and/or status information 531 describing the doctor, location information describing the doctor 532, travel information describing the doctor's travel mode or abilities 533, and acceptance/declination component 534 to permit a doctor to accept or decline a patient's request for the provision of medical services, a medical resources component 535 that may provide the doctor with reference information regarding the provision of medical services, such as dosing information or diagnostic guides, etc. A base location describing the home or office of a doctor may comprise a portion of personal/practice information 531 and/or doctor location information 532. An optional base location may comprise a particular location, such as an address or GPS coordinates, but may also comprise a bounded geographical area, such as on or more municipal city limits. Doctor component may further provide a medical records, charts and notes component 536. A patient component 520 may exchange information with coordination component 510 via a connection 542. Similarly, a doctor component 530 may exchange information with a coordination component 510 via a connection 543. Communications and information exchanged between a patient component 520 and a coordination component 510 via connection 542 may be bidirectional, as may be information exchange between a doctor component 530 and a coordination component 510 via a connection 543.

A coordination component 510 may further interface with additional information sources to facilitate the systems and methods for delivery of medical services in accordance with the present invention. For example, navigational information 552 may be accessed via a connection 562. Navigational information may describe, for example, traffic transit information, such as weather information, that may be pertinent to the route for time required in order for a doctor at a doctor's location to reach a patient at a patient's location. Information received from a navigational information component 552 may be used for a coordination component 510 to match a doctor with a patient request for medical services.

Further, a coordination component 510 may access one or more payment processing component 554 via a connection 564. The one or more payment processing component 564 may comprise, for example, a credit card processing system, a banking system, or any other type of means for making or receiving payments.

Coordination component 510 may further access backup and/or storage component 556 via connection 566. Backup and/or storage component 556 may provide a means to store or backup information pertinent to coordination component 510, patient component 520, and/or doctor component 530.

While systems and methods in accordance with the present invention need not involve any type of medical insurance, optionally a coordination component 510 may interface with one or more insurance component 558 via a connection 568 in order to approve and/or obtain payment for the provision of medical services in accordance with the present invention.

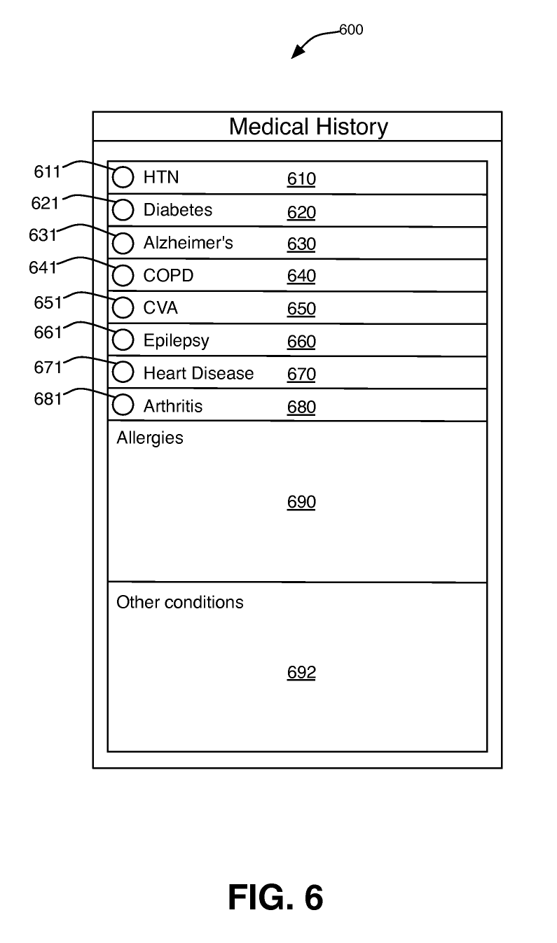

Example interfaces that may be used to enter information relevant to the provision of medical services using systems and methods in accordance with the present invention are illustrated in FIGS. 6-9. Interfaces used to present and/or receive information in accordance with the present invention may be adapted to the type of computing device used. For example, an interface for use on a smart phone or tablet computer might receive information via touch-based inputs, while an interface for use on a PC may receive inputs through a keyboard and/or mouse. The present examples of interfaces for use in systems and methods in accordance with the present invention are illustrative only. The present invention may be implemented with other types of computing devices using other types of outputs and/or inputs than illustrated and described in the examples of FIGS. 6-9.

Referring now to FIG. 6, a portion of an example interface 600 that may be used to gather a medical history for a patient is shown. Interface 600 may present medical conditions and a selectable indicator corresponding to each medical condition to permit a patient, doctor or other person entering information using interface 600. The medical conditions used for the example of FIG. 6 are illustrative only, and systems and methods in accordance with the present invention may collect a more extensive and/or different medical history than shown in the present example. In the example of FIG. 6, a hypertension field 610 may be selected using indicator 611, a diabetes field 620 may be selected using indicator 621, an Alzheimer's field 630 may be selected using indicator 631, a chronic obstructive pulmonary disease field 640 may be selected using indicator 641, a cerebrovascular accident field 650 may be selected using indicator 651, an epilepsy field 661 may be selected using indicator 671, and an arthritis field 680 may be selected using indicator 681. Any number of fields and indicators may be used in accordance with the present invention, and indicators need not be discrete from the associated field. Also, in some examples of the present invention the selection of a particular field, such as a field indicating that a patient is pregnant, may result in the presentation of an interface 600 with further medical condition fields particularly pertinent to the selected field, such as preeclampsia for a patient who has indicated a pregnancy. A text field 690 may receive allergy information in a text form, while a further text field 692 may receive any other medical information deemed potentially pertinent in a text form. Additional and/or different text fields may be provided in an interface beyond these examples. An interface such as the example interface 600 depicted in the example of FIG. 6 may operate on a patient computing, a doctor computing device, or any other computing device.

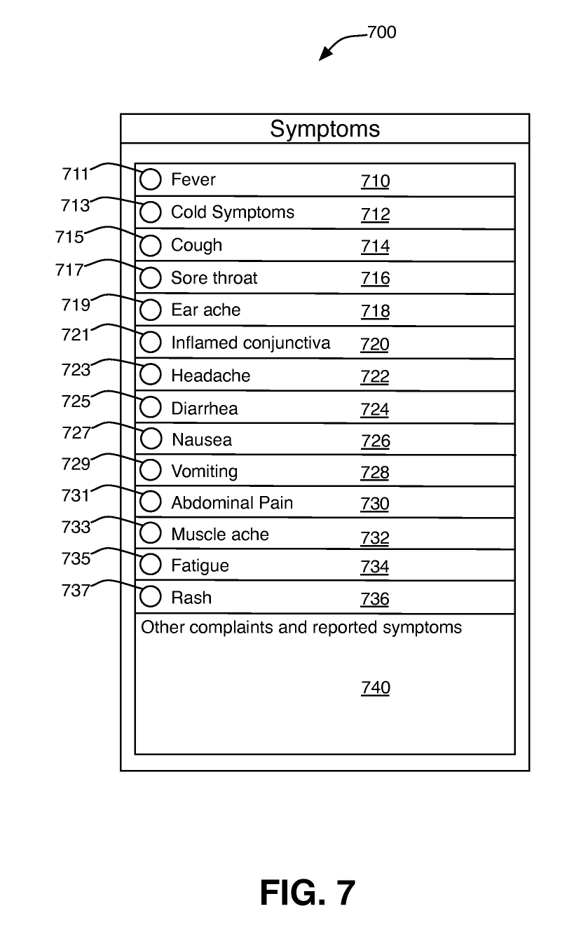

Referring now to FIG. 7, an example interface 700 for use in collecting symptomatic information describing a patient is illustrated. As was the case with regard to FIG. 6, the example interface 700 of FIG. 7 is illustrative only. The example interface 700 may present symptom fields, each having a corresponding selectable indicator. In the example interface 700 of FIG. 7, a fever field 710 may be selected using indicator 711, a cold symptoms field 712 may be selected using indicator 713, a cough field 714 may be selected using indicator 715, a sore throat field 716 may be selected using indicator 717, an ear ache field 718 may be selected using indicator 719, an inflamed conjunctiva field 720 may be selected using indicate 721, a headache field 722 may be selected using indicator 723, a diarrhea field 724 may be selected using indicate 725, a nausea field 726 may be selected using indicator 727, a vomiting field 728 may be selected using indicator 729, an abdominal pain field 730 may be selected using indicator 731, a muscle ache filed 734 may be selected using indicator 735, and a rash field 736 may be selected using indicator 737. A text field 740 may receive text describing other symptoms experienced by a patient. As with the example interface 600 for collecting a patient medical history shown in FIG. 6, more and/or different symptoms may be presented than shown in the example interface 700 depicted in FIG. 7, and the selection of fields corresponding to some symptoms may result in the presentation of a further interface pertinent to further describing or refining the previously selected symptom.

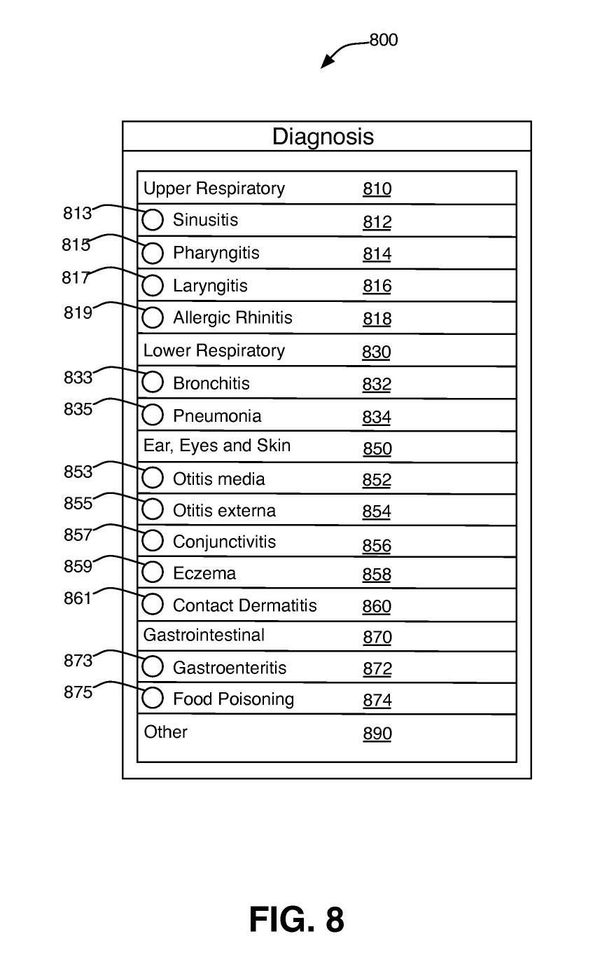

Referring now to FIG. 8, an example interface 800 for entering diagnostic information is illustrated. The example interface 800 may operate on a doctor computing device, but may operate on any type of computing device in accordance with the present invention. As with the examples of FIGS. 6 and 7, example interface 800 is illustrative only, and diagnoses in addition to and/or instead of those illustrated in the example of FIG. 8 may be provided in systems and methods in accordance with the present invention. Interface 800 may provide a doctor with potential diagnoses grouped by category, but may organize potential diagnoses in any way. For example, interface 800 may provide an upper respiratory category 810, a lower respiratory category 830, an ears, eyes, and skin category 850, a gastrointestinal category 870, and an other category 890, although additional and/or different categories may be used, or no categories may be provided at all. Interface 800 may present diagnosis fields, each having a corresponding selectable indicator. For example, a sinusitis field 812 may be selected using indicator 813, a pharyngitis field 814 may be selected using indicator 815, a laryngitis field 816 may be selected using indicator 817, an allergic rhinitis field may be selected using indicator 819, a bronchitis filed 832 may be selected using indicatory 833, a pneumonia field 834 may be selected using indicator 835, an otitis media field 852 may be selected using indicator 853, an otitis externa field 854 may be selected using indicator 855, conjunctivitis field 856 may be selected using indicator 857, an eczema field 859 may be selected using indicator 859, a contact dermatitis field 860 may be selected using indicator 861, a gastroenteritis field 872 may be selected using indicator 873, and a food poisoning field 874 may be selected using indicator 875. A text box (not illustrated) such as shown in the examples of FIGS. 6 and 7 may additionally/alternatively provided to enable a textual description of a diagnosis to be entered using interface 800. Similarly to the example interfaces 600, 700 shown in FIGS. 6 and 7, more and/or different diagnoses may be presented than shown in the example interface 800 depicted in FIG. 8, and the selection of fields corresponding to some diagnoses may result in the presentation of a further interface pertinent to further describing or refining the previously selected diagnosis.

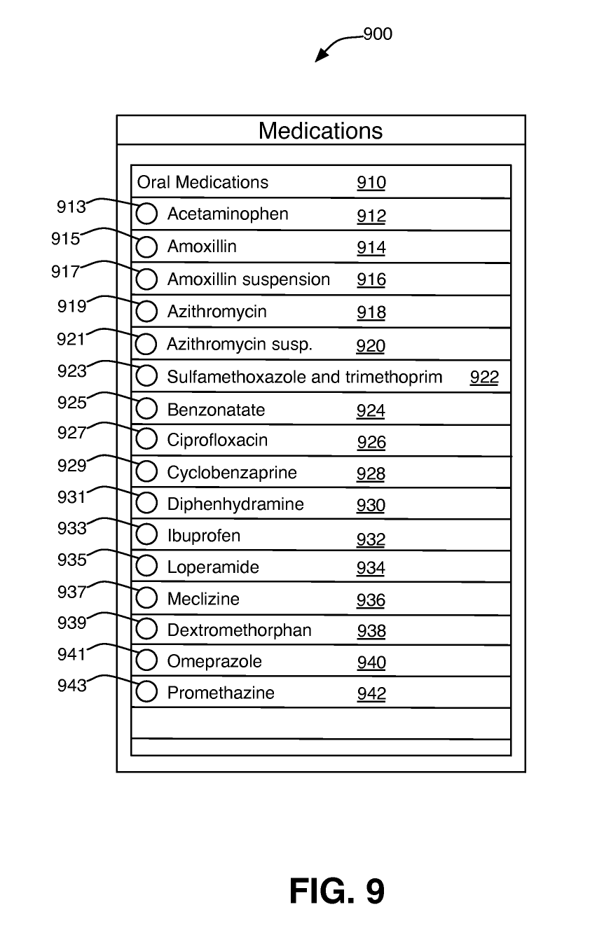

Referring now to FIG. 9, an example interface 900 for entering medication information is illustrated. The example interface 900 may operate on a doctor computing device, but may operate on any type of computing device in accordance with the present invention. As with the examples of FIGS. 6, 7 and 8, example interface 900 is illustrative only, and medications and/or treatments in addition to and/or instead of those illustrated in the example of FIG. 9 may be provided in systems and methods in accordance with the present invention. Interface 900 may provide a doctor with potential medications and/or treatments grouped by category, but may organize potential medications and/or treatments in any way. For example, interface 900 may provide may provide an oral medication category 910. Interface 900 may present medication/treatment fields, each having a corresponding selectable indicator. For example, an acetaminophen field 912 may be selected using indicator 913, an amoxillin field 914 may be selected using indicator 915, an amoxillin suspension field 916 may be selected using indicator 917, an azithromycin field 918 may be selected using indicator 919, an azithromycin suspension field 920 may be selected using indicator 921, a sulfamethoxazole and trimethoprim field 922 may be selected using indicator 923, a benzonatate field 924 may be selected using indicator 925, a ciprofloxacin field 926 may be selected using indicator 927, a cyclobenzaprine field 928 may be selected using indicator 929, a diphenhydramine field 930 may be selected using indicator 931, an ibuprofen field 932 may be selected using indicator 933, a loperamide field 934 may be selected using indicator 935, a meclizine field 936 may be selected using indicator 937, a dextromethorphan field 938 may be selected using indicator 939, an omeprazole field 940 may be selected using indicator 941, and a promethazine field 942 may be selected using indicator 943. Other interface components, such as a text box (not shown) may be provided to receive information describing a medication and/or treatment provided to a patient by a doctor. Treatments beyond oral medications may be entered into interface 900 and/or an additional interface, such as injections, medical devices or supplies (such as splints, bandages, and the like), therapeutic procedures, and any other treatment.

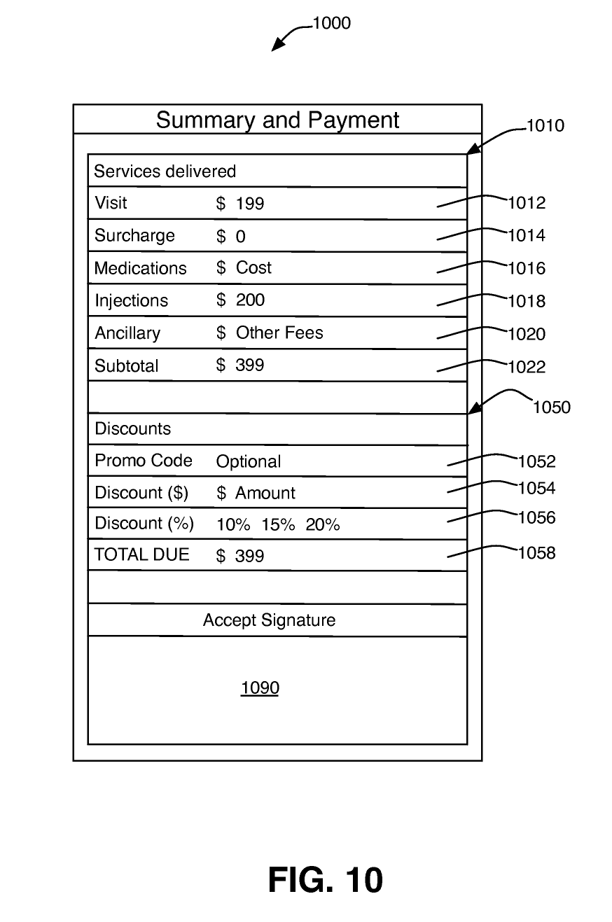

Referring now to FIG. 10, an example payment interface 1000 that may be used to conclude the delivery of medical services and process an appropriate payment for those services is illustrated. The example interface 1000 may operate on a doctor computing device, but may operate on any type of computing device in accordance with the present invention. Example payment interface 1000 illustrates only one example of a possible payment interface that may be used in systems and methods in accordance with the present invention. In some examples a payment interface may not be required at every provision of medical services, for example if a patient participates in a monthly or other type of membership plan that entitles him or her to the provided medical services. Additional and/or different information than shown in the example of FIG. 10 may be used for transacting a payment for the delivery of medical services. In the example of FIG. 10, a charges category 1010 may identify the relevant charges for particular medical services in corresponding fields. For example, a visit charge field 1012 may present the base fee for a medical services visit, in the present example $199. The amount of the base fee enumerated in visit charge field 1012 may vary based upon location or region, medical specialty, doctor experience, patient membership status (and may be zero in some instances) and/or other factors. A surcharge field 1014 may present any surcharge added to the base fee, for example due to a visit being requested with particular urgency, at an unusual hour, requiring extremely long travel, and/or other factors. A medication charge field 1016 and an injection charge field 1018 may show the amount billed for any medications or injections administered, respectively, which may be calculated based upon entries made using interface 900 to describe medications or other treatments administered as part of the provided medical services. An ancillary charge field 1020 may show the amount billed for medical equipment, supplies, procedures, etc., and may be calculated based upon entries made using interface 900. A discount category 1050 may show any discounts applied to the bill, such as discounts based upon a promotional code in field 1052, an absolute discount amount in field 1054, and/or a percentage discount in field 1056. Payment interface 1000 may access information regarding applicable promotional codes stored locally (for example, on the doctor computing device), on a coordination component via a network, or through other means. Percentage discount field 1056 and/or absolute discount field 1054 may receive a numeric entry, but may alternatively/additionally present selectable predetermined values. The total amount due in payment for the provision of medical services may be determined by summing the amounts in fields of charges category 1010 and subtracting the amounts entered into and/or calculated based upon entries in fields of discount category 1050, and the total due may be presented in field 1080. A signature field 1090 may be signable, for example using a stylus or a finger on a touch sensitive screen of a doctor computing device, to acknowledge the charges and/or to authorize payment. A payment processing system, such as a card reader, may be provided, but any manner of payment receipt and/or payment processing may be used with systems and methods in accordance with the present invention.

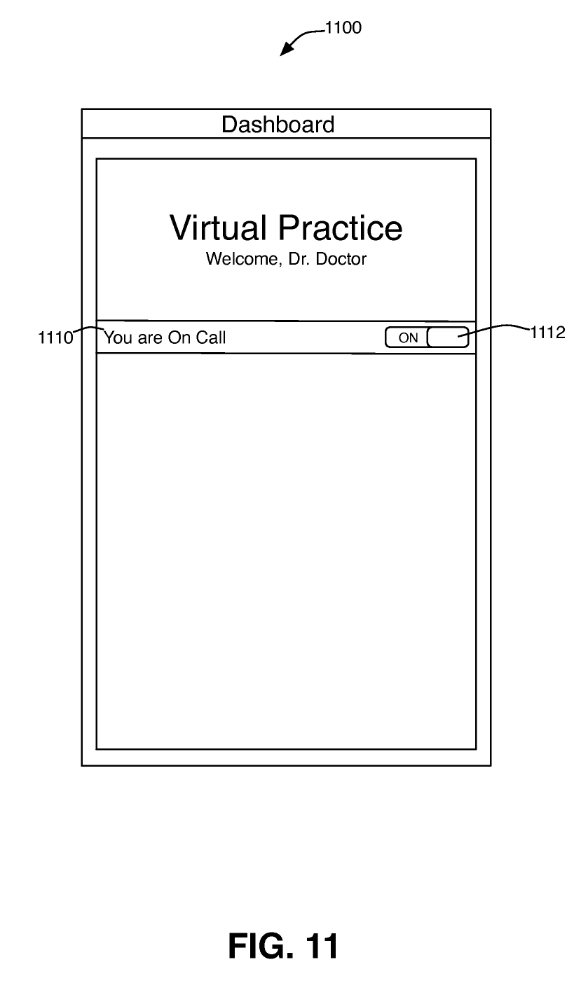

Referring now to FIG. 11, an interface 1100 for a doctor computing device for use in indicating/modifying the on-call status of a doctor is illustrated. While a variety of menus, selectable options, and other types of interface mechanisms may be used for an interface such as example interface 1100 to indicate the on-call status of a doctor, in the present example a switchable indicator 1112 may be used to toggle between an on call status and a not on call status for a doctor. As shown in the example of FIG. 11, indicator 1112 has been toggled to an on call status, as indicated by text description 1110. By toggling indicator 1112 to an off position, the descriptor 1110 may change from “you are on call” to “you are not on call” in order to indicate to a doctor using a doctor computing device his or her on-call status. As described in examples herein, the on call status of a doctor need not be merely binary, as illustrated in the example of FIG. 11. In some examples, a doctor's on call status may be defined based upon the distance or time required to travel to a patient location (with a doctor willing to accept requests only from patients reachable within a certain period of time), the history of a doctor with a given patient (for example, a doctor may be willing to accept requests only from some or all of that doctor's prior patients), a distance (and/or time required to travel a given distance) between a patient location and a base location associated with the doctor or any other criteria.

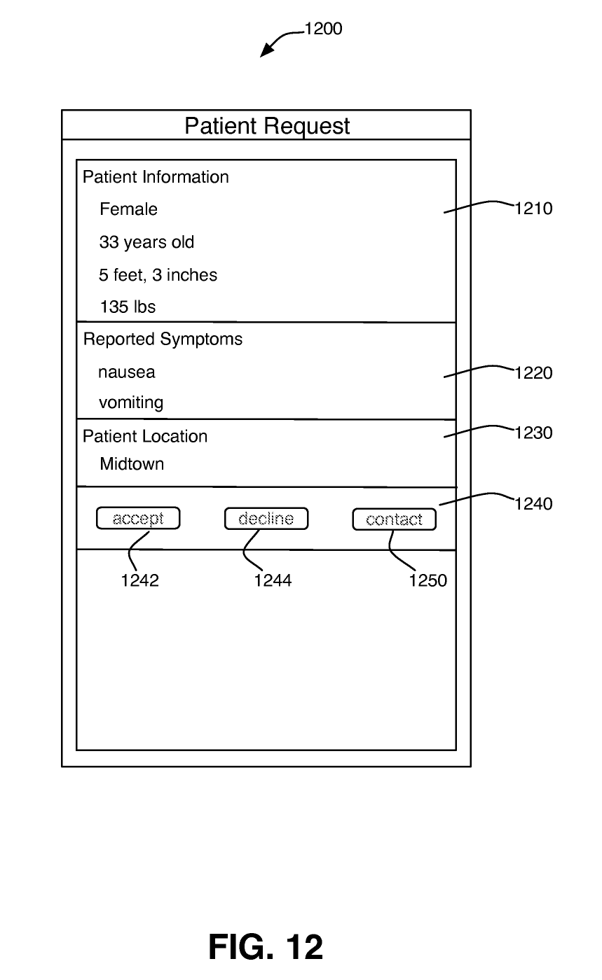

Referring now to FIG. 12, a patient request notification interface 1200 is illustrated. Patient request notification interface 1200 may be presented to a doctor to notify the doctor of a request for medical services that has been matched by a coordination component to the doctor using the doctor computing device. Patient request notification interface 1200 may also provide pertinent information to a doctor describing the patient and/or the medical request. Information provided may be sufficient to enable the doctor to determine whether he or she can provide the requested medical services while also being sufficiently anonymized to protect the privacy of the patient requesting the medical services.

In the example patient request notification interface 1200 of FIG. 12, a patient information field 1210 may provide relevant physiological information for patient associated with the request for medical services. For instance, in the example of FIG. 12 the patient physiological information display 1210 identifies the patient requesting medical services as female, 33 years in age, 5 feet and 3 inches in height, and 135 pounds in weight. Any other type of information may be presented in a patient information field 1210, such as a description of an acute or chronic condition experienced by a patient of potential pertinence to a doctor initially evaluating a request for medical services.

A symptom information display field 1220 may provide a description of the symptoms reported by a potential patient in conjunction with a request for medical services. In the example of FIG. 12, symptom information display 1220 lists nausea and vomiting as the symptoms experienced by the patient requesting medical services. Symptom information display field 1220 may provide some or all of the symptoms reported by a patient and associated with a request for medical services, and any symptoms reported by a patient may be summarized for presentation to a doctor in a symptom information display 1220.

A patient location display field 1230 may provide information to a doctor regarding the location of a patient, which may be particularly useful for a doctor in determining whether he or she can navigate to the patient location to provide the requested medical services. The information displayed in patient location display 1230 may be genericized or anonymized in order to protect the confidentiality and privacy of the potential patient, but may simply identify an address corresponding to the patient location information. In the example shown in FIG. 12, patient location display 1230 simply identifies a patient as located in “Midtown,” but any description of a patient location may be used. Patient location display 1230 may identify the patient location in a variety of ways, such as identifying a particular town or part of a town or metropolitan area describing the patient location, by identifying a block or range of street addresses describing the patient location, by illustrating the general area of a patient location using a map display, or through any other means.

A decision component 1240 may permit a doctor to accept a request to provide medical services using an accept button 1242, to decline a request to provide medical services with a decline button 1244, and/or to request a communication with a potential patient using a contact button 1250. Decision component 1240 is exemplary only, and may be provided in a different interface than interface 1200 and/or may provide additional, different, or fewer options than those illustrated in the present example. Further, the options illustrated in the example decision component 1240 of FIG. 12 may be distributed differently within decision component 1240 and/or other components of a doctor interface.

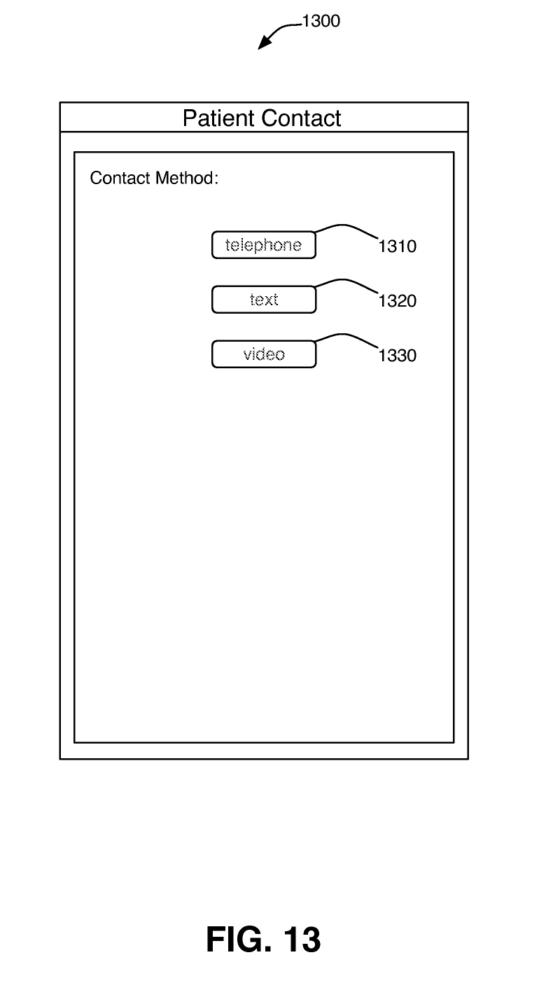

Referring now to FIG. 13, an example of a patient communication interface 1300 that may enable a doctor operating a doctor computing device to communicate with a potential patient is illustrated. In the present example, patient communication interface 1300 may be provided to a doctor on a doctor computing device after the selection by the doctor of the contact button 1250, but in some examples patient communication interface 1300 may not be required or provided, for example if only a single type of communication between a doctor and a potential patient is possible or if no bi-directional communication between a doctor and a potential patient is possible. Alternatively, exemplary contact button 1250 or an equivalent may be omitted, and instead patient communication interface 1300 may be used by a doctor to initiate a communication with a patient only if the doctor using the doctor computing device desires such a communication. In the example of FIG. 13, a doctor wishing to communicate with a potential patient, for example to determine whether the patient requires a type of medical services the doctor can provide, may be indicated by the selection of an appropriate button to communicate to a coordination component a request to initiate the selected type of bi-directional and optionally at least partially anonymized communication. For example, selecting a telephone button 1310 may initiate a telephone call between the doctor and the patient, which may utilize the doctor computing device (if it possess such functionality), the patient computing device (if it possesses such functionality), or other telephones associated with the doctor and/or patient. Such a telephone call may be a two-legged call such as described in examples above, but may be any type of call. In some examples, rather than establishing a telephone call through PSTN and/or wireless telecommunications protocols, a VoIP call may be established. A text button 1320 may be used to indicate a desire to initiate a text based communications exchange with a potential patient, with such communications optionally flowing through and/or initiated by the coordination component. A video button 1330 may be selected to indicate a desire to initiate a videoconference with a potential patient, potentially using the coordination component as an intermediary between a doctor computing device and a patient computing device or other endpoints for such a video conference. The types of communications available as a contact method may vary from those illustrated in FIG. 13, either by having more or fewer or different communication methods. Some or all of the available communication methods that a doctor may optionally select may be non-anonymized, partially anonymized, or entirely anonymized. A coordination component may facilitate the anonymization of such communications by serving as an intermediary or middle point that receives and then re-transmits communications from either side of the communication to eliminate potentially identifying information. However, other means of at least partially anonymizing the requested communications may be used, or communications may simply not be anonymized.

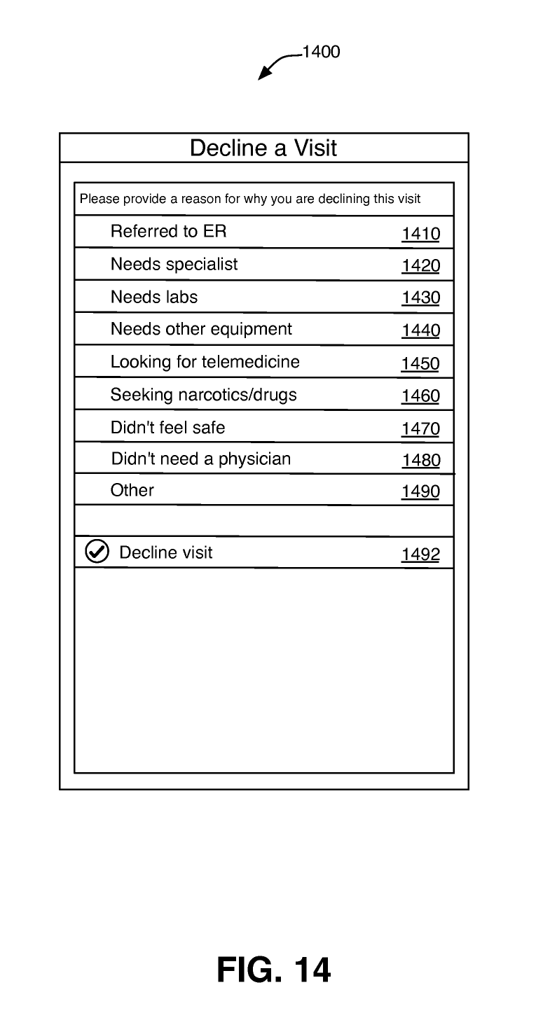

Referring now to FIG. 14, a declination interface 1400 is illustrated. If a doctor has opted to decline a request for medical services, for example using the decline button 1244 illustrated in the example of FIG. 12, declination interface 1400 may be presented to the doctor on the doctor computing device to record the reason for the doctor to decline the request for medical services. A doctor may select one or more of the reasons provided for declining a request for medical services. The reasons for declining a request for medical services need not be limited to or include all of those illustrated in the example of FIG. 14, and declination interface may be omitted or modified. In the example of FIG. 14, potential reasons to decline a request for medical services comprise that the patient was referred to the emergency room 1410, that the patient needs a medical specialist 1420, that the patient needs laboratory work not available to the doctor 1430, that the patient needs medical equipment not available to the doctor 1440, that the patient was seeking telemedicine rather than any in-person delivery of medical services 1450, that the patient seemed to be seeking narcotics, drugs, or some other illicit purpose 1460, that the doctor did not feel safe to provide the requested medical services 1470, that the patient did not actually require a physician 1480, or any other reason 1490. Upon selecting one or more reason to decline a visit, a doctor may confirm that declination of the request for medical services by choosing indicator 1492, which may then result in the doctor computing device communicating both the declination of the request for medical services by the doctor and the reason for the declination to a coordination component. A coordination component may optionally proceed in a fashion at least partially dependent upon a reason for declining a request for medical services by a doctor. For example, if a doctor indicates that a patient requires medical equipment not available to the doctor 1440, a coordination component may seek to match the request for medical services to a doctor either known to possess or likely possessing the needed equipment, but if a doctor indicates that the patient was referred to an emergency room 1410 information regarding seeking emergency medical services, optionally based upon patient location data, may be provided to a patient computing device.

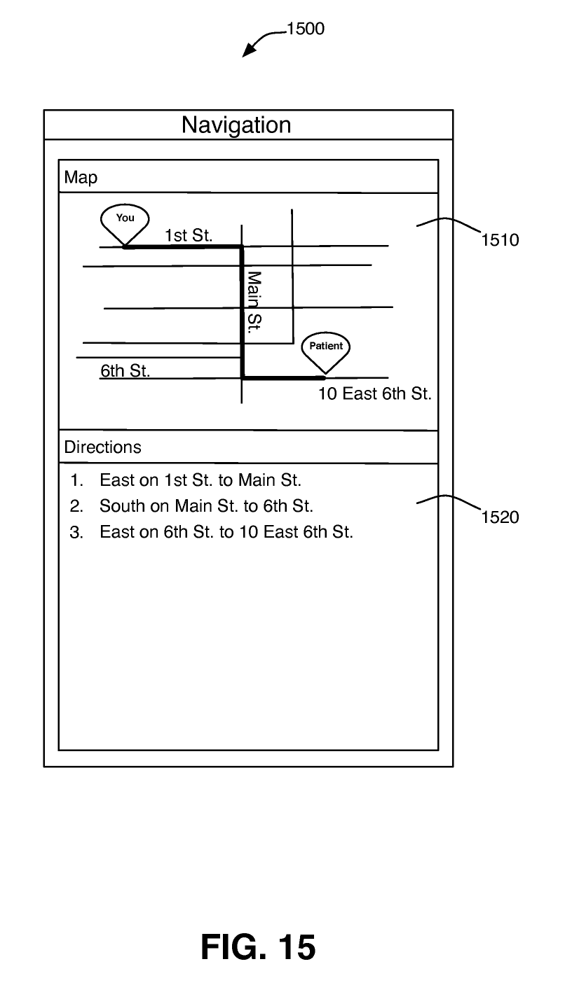

Referring now to FIG. 15, a navigation interface 1500 is illustrated. Navigation interface 1500 may be displayed on a doctor computing device and used by the doctor to navigate from the doctor location to the patient location after a doctor has accepted a request for medical services. In the example shown in FIG. 15, navigational directions are provided in the form of a map 1510 and in the form of text based directions 1520. Any other type of navigational instructions, such as spoken instructions sometimes referred to as turn-by-turn directions, may be provided by a navigational component of a doctor computing device in accordance with the present invention. In some examples, a doctor may have accepted multiple requests for medical services and, in such an example, a navigation interface may provide the relative locations of patients awaiting the delivery of medical services and/or suggest optimal routes between multiple patient locations.

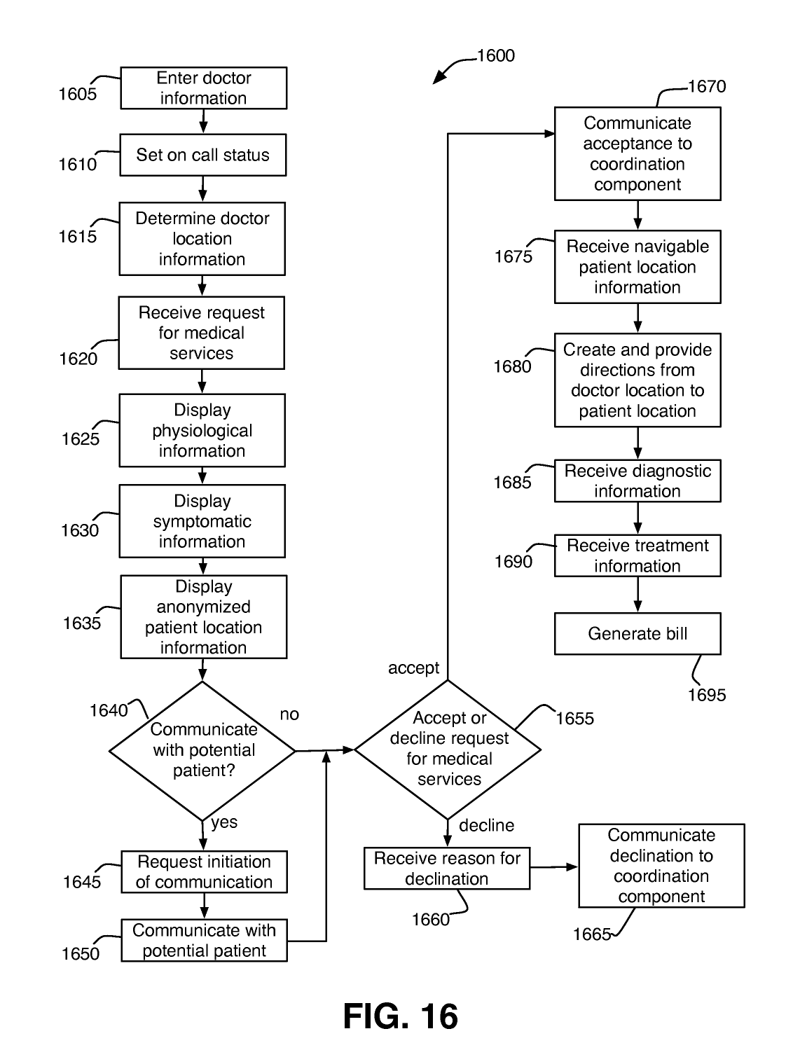

Referring now to FIG. 16, a method 1600 for a doctor to provide medical services to patients is illustrated. In step 1605 doctor information may be entered. Step 1605 may utilize, for example, a doctor computing device or other data entry methodology to provide a coordination component with information describing a doctor, the doctor's training, the doctor's medical specialty, the doctor's medical experience, the doctor's preferences in treating patients, the doctor's gender, the doctor's language skills, the doctor's base location, or any other information that may be relevant to the delivery of medical services and/or the matching of a doctor to a request for medical services by patient.

In step 1610 a doctor may set his or her on call status. Step 1610 may comprise a simple binary selection to be either on call or not on call by a doctor, but may involve a more complex designation of the types of requests for medical services a doctor is willing to accept. If the result of step 1610 is to set a doctor's call status to not be on call or to otherwise not be available to perform or provide any medical services, the remainder of method 1600 may optionally the aborted for that doctor.

In step 1615, doctor location information may be determined for a doctor. Doctor location information may be determined, for example, using location services operating on a doctor computing device. Doctor location information may be determined continuously or on a frequent basis that is sufficient to communicate to a coordination component an adequately accurate description of the location of the doctor for use in matching doctor to a patient request for medical services.

If a coordination component has matched a doctor to a patient request for medical services, method 1600 may proceed to step 1620 of receiving the request for medical services, for example on a doctor computing device. In conjunction with step 1620 of receiving the request for medical services, a doctor computing device may display physiological information associated with the request in step 1625, may display symptomatic information associated with the request in step 1630, and may display optionally anonymized patient location information associated with the request in step 1635.

A doctor may determine whether to communicate with a potential patient in step 1640. The communication in question may be any type of bidirectional communication that may optionally be partially or entirely anonymized to protect the privacy of the patient and/or the doctor. A doctor may indicate a decision to communicate with a potential patient (or not) using a doctor computing device. Optionally, a doctor may select a preferred mode of communication with the potential patient as well.

If the result of step 1640 is to communicate with a potential patient, the doctor's indication of the desire to communicate with the potential patient may optionally result in a request for an initiation of communication by the doctor computing device being transmitted to the coordination component to establish the requested communication. Method 1600 may then proceed to step 1650, wherein the doctor may communicate with the potential patient using the available or selected communication methodology.

If the doctor determines in step 1640 not to initiate a communication with the patient, or if step 1640 is not provided in a given implementation of method 1600, or if the doctor has completed the desired communication with the potential patient, method 1600 may proceed to step 1655 to determine whether the doctor will accept or decline the request to provide medical services. Step 1655 may be performed using a doctor computing device. In some examples of the present invention, any of steps 1640, 1645, and/or 1650 involving establishing a communication with a patient may alternatively/additionally occur after the acceptance of a request for medical services in step 1655. If the result of step 1655 is to decline the request to deliver medical services, method 1600 may proceed to step 1660 to receive a reason for the declination from the doctor. Method 1600 may then proceed to step 1665 to communicate the declination and optional reason for the declination to a coordination component. After step 1665, the coordination component may seek to perform another match of a doctor to the request for medical services, notify the potential patient of the declination of the request for medical services or take other actions.

If the result of step 1655 is that the doctor has accepted the request provide medical services, method 1600 may proceed to step 1670 to communicate the acceptance to the coordination component. In response to the communication of the acceptance of the request to provide medical services, method 1600 may proceed to step 1675 of receiving navigable patient location information at a doctor computing device from a coordination component. Step 1675 may optionally involve receiving potential route information from the doctor location to a patient location from a coordination component, but may alternatively/additionally involve providing patient location information sufficient to permit the doctor computing device to generate travel directions, either independently or in combination with other computing devices. Based upon the navigable patient location information received in step 1675, in step 1680 navigational directions may be created and/or provided from the doctor location to the patient location. If navigable patient location information was previously delivered to the doctor computing device, for example as part of step 1620 of receiving a request for medical services, step 1680 may be omitted or combined with such a prior step.

During or after the delivery of the requested medical services, method 1600 may proceed to step 1685 of receiving diagnostic information and to step 1690 of receiving treatment information. Steps 1685 and 1690 may be performed using the doctor computing device to create or modify electronic medical records corresponding to the patient and the medical services provided to the patient by the doctor.

Method 1600 may conclude with the generation of a bill for the requested medical services. Step 1695 may be based, at least in part, upon the treatment information received in step 1690. The generation of a bill in step 1695 may also be based upon information such as enrollment information regarding the patient receiving the medical services, the time at which the medical services were provided, the location at which the medical services were provided, the identity and/or specialty or experience of the doctor providing the medical services, or any other criteria. In response to the generation of a bill in step 1695, a patient may indicate an acceptance of the bill by signing or otherwise acknowledging the bill and/or paying the amount due.

Systems and methods in accordance with the present invention may exchange information, medical and otherwise, from a patient computing device through one or more computing devices comprising a coordination component, and one or more doctor computing devices in order to match patient needs with available doctors. In this fashion, a wide variety of patient medical needs may be met by a wide variety of doctors. While in the present examples a doctor often travels to a patient location, systems and methods in accordance with the present invention may be implemented in other fashions. For example, a patient may travel to the doctor, or both the patient and the doctor may travel to a single different location. Such variations do not depart from the scope of the present invention.

Systems and methods in accordance with the present invention are not limited to particular types of computing devices, any given number of computing devices utilized for a patient computing device, a doctor computing device, and/or a coordination component. Further, systems and methods in accordance with the present invention may utilize one or many different networks, types of network, communication protocols, and/or communication media. Systems and methods in accordance with the present invention may involve machine or computer executable instructions embodied in non-transitory media to cause one or more machine or computer to execute systems and methods in accordance with the present invention. The present invention may be embodied in any type of non-transitory media and may take form, format, or other type that may cause a computer processor or other machine to execute those instructions. The present invention is not limited to any computing architecture, processor type, software language type, or other approach.

1. A doctor computing device for use in providing medical services to patients, the doctor computing device comprising:
at least one network communication component that sends and receives communications over at least one network, the communications exchanged with at least one coordinating component and at least one patient computing device;
a status designation interface that permits the doctor using the doctor computing device to set an on-call status indicative of the availability of the doctor for providing medical services;
a doctor location component that obtains information describing the location of the doctor computing device and communicates that location information using the at least one network communication component to the at least one coordinating component;
a patient information display component that displays information describing physiological and symptomatic information regarding a potential patient, the physiological and symptomatic information initially entered into a patient computing device and received by the doctor computing device using the at least one network communication component;
a bi-directional communication component that receives an input from the doctor using the doctor computing device indicating a desire to communicate with the potential patient providing the physiological and symptomatic information and, at the initiation of the at least one coordinating component, exchanges at least partially anonymized bi-directional communications using the at least one network communication component with the patient computing device;
a medical request acceptance/declination interface that receives an input from the doctor using the doctor computing device indicating one of an acceptance of a request for medical services from a potential patient and a declination of a request for medical services from a potential patient and communicates the acceptance/declination to the at least one coordination component using the at least one network communication component;
a navigational component that, upon acceptance of a request for medical services from a potential patient, provides instructions permitting the doctor using the doctor computing device to reach the location of the potential patient requesting medical services;
a medical records component that presents the doctor using the doctor computing device a plurality of potential diagnoses and treatments and receives selections from the doctor indicating at least one diagnosis made by the doctor and at least one treatment provided by the doctor; and
a billing component that determines a bill amount based upon at least the inputs made by the doctor using the medical records component.

2. The doctor computing device of claim 1, wherein the medical request acceptance/declination interface further receives a reason for a declination of a request for medical services.

3. The doctor computing device of claim 2, wherein the medical request acceptance/declination interface receives a reason for a declination of a request for medical services by providing a selectable list of potential reasons for a doctor to identify for declining a request for medical services.

4. The doctor computing device of claim 3, wherein the selectable list of potential reasons for declining the request for medical services at least comprises options of the patient requiring emergency medical treatment and the belief that the patient is seeking medications for illicit purposes.

5. The doctor computing device of claim 3, wherein the medical records component presents additional selectable options for a diagnosis in response to at least some selections by a doctor of a prior selectable option of a doctor to indicate a diagnosis.

6. The doctor computing device of claim 5, wherein
the bi-directional communication component provides a doctor a plurality of options for the type of at least partially anonymized bi-directional communication to be initiated.

7. The doctor computing device of claim 6, wherein one of the plurality of options for the type of at least partially anonymized bi-directional communication to be initiated is a telephone call.

8. The doctor computing device of claim 6, wherein the plurality of options for the type of at least partially anonymized bi-directional communication comprises at least a telephone call and a text based message exchange.

9. The doctor computing device of claim 5, wherein the billing component further determines a bill amount based upon enrollment information for the patient received from a coordination component using the at least one network communication component.

10. A method for providing medical services to a patient, the method comprising:
at a doctor computing device operated by a doctor, receiving an on call designation status describing the availability of the doctor to provide medical services and communicating the on call designation status to a coordination component using at least one network communication interface;
at the doctor computing device, determining doctor location information describing the physical location of the doctor computing device and communicating the doctor location information to the coordination component using the at least one network communication interface;
receiving a request for medical services from a potential patient on the doctor computing device, the request for medical services received from the coordination component using the at least one network communication interface;
at the doctor computing device, prompting the doctor using the doctor computing device to accept the request to provide medical services or decline the request to provide medical services;
at the doctor computing device, providing the doctor using the doctor computing device a selectable option to anonymously communicate bi-directionally with the potential patient and, if the doctor selects to anonymously bi-directionally communicate with the potential patient, communicating that selection to the coordination component using the at least one network communication interface and, at the coordination component, initiating an anonymous bi-directional communication between the doctor computing device and the potential patient;
if the doctor declines the request to provide medical services, communicating the declination to the coordinating component using the at least one network communication interface; and
if the doctor accepts the request to provide medical services,
communicating the acceptance to the coordinating component using the at least one network communication interface,
upon receiving the acceptance at the coordination component, receiving at the doctor computing device from the coordinating component patient location information at the doctor computing device using the at least one network communication interface and providing directions on the doctor computing device enabling the doctor to travel to the location of the patient,
receiving on the doctor computing device diagnostic information and treatment information from the doctor, the diagnostic information and treatment information descriptive of the medical services provided by the doctor, and
generating a bill for the provided medical services at the doctor computing device, the bill generated at least in part based upon the treatment information.

11. The method for providing medical services of claim 10, wherein receiving a request for medical services further comprises receiving physiological information and symptomatic information describing the potential patient requesting medical services, the method further comprising displaying the physiological information and symptomatic information to the doctor.

12. (canceled)

13. The method for providing medical services of claim 10, further comprising, if the doctor selects to anonymously bi-directionally communicate with the potential patient, receiving at the doctor computing device an anonymous bi-directional communication with the potential patient initiated by the coordination component.

14. The method for providing medical services of claim 10, further comprising, if the doctor declines the request to provide medical services, prompting the doctor for a reason for declination.

15. The method for providing medical services of claim 14, wherein the doctor may select one of a plurality of reasons for declining the request to provide medical services, the reasons for declining the request to provide medical comprising at least the conclusion that the potential patient required emergency medical services.

16. The method for providing medical services of claim 15, wherein receiving on the doctor computing device diagnostic information and treatment information from the doctor, the diagnostic information and treatment information descriptive of the medical services provided by the doctor further comprises presenting at least one set of selectable diagnostic options and at least one list of selectable treatment options.

17. The method for providing medical services of claim 16, wherein presenting at least one set of selectable diagnostic options comprises presenting at least a second set of selectable diagnostic options based upon a selection from the at least one set of selectable diagnostic options.

18. The method for providing medical services of claim 15, further comprising communicating the diagnostic information and the treatment information from the doctor computing device to the coordination component using the at least one network communication interface.
